(19) United States
(12) Patent Application Publication
(10) Pub. No.: US 2015/0271643 A1
(43) Pub. Date: Sep. 24, 2015

(54) POSITION DETERMINATION USING TIME OF ARRIVAL MEASUREMENTS IN A WIRELESS LOCAL AREA NETWORK

(71) Applicant: Ahmad Jalali, Rancho Santa Fe, CA (US)

(72) Inventor: Ahmad Jalali, Rancho Santa Fe, CA (US)

(21) Appl. No.: 14/731,780

(22) Filed: Jun. 5, 2015

Related U.S. Application Data
(63) Continuation-in-part of application No. 14/284,384, filed on May 21, 2014.
(60) Provisional application No. 61/944,115, filed on Feb. 25, 2014.

(51) Int. Cl. H04W 4/02; G01S 1/04; G01S 5/06

(52) U.S. Cl. CPC H04W 4/023; G01S 5/06; G01S 1/04; H04W 84/12

(57) ABSTRACT

Ways to determine position or proximity of elements such as tags or mobile devices within a wireless local area network such as an IEEE 802.11 network that includes multiple beacons using time of arrival (TOA) of messages are described. System and methods are described for invoking TOA measurements at the beacons, the systems and methods being compatible with IEEE 802.11 protocols and signaling. Systems and methods are described to estimate the clock offset among beacons in an asynchronous network of IEEE 802.11 enabled Beacons, and to compensate for the clock timing offsets of the measured TOA values when triangulating the TOA values to estimate tag and/or mobile device positionlocation.

### CROSS-REFERENCE TO RELATED APPLICATIONS

This application is a continuation-in-part of U.S. patent application Ser. No. 14/284,384, filed on May 21, 2014. U.S. patent application ser. No. 14/284,384 claims priority to U.S. Provisional Patent Application Ser. No. 61/944,115, filed on Feb. 25, 2014.

### BACKGROUND

The invention generally relates to location and tracking and more specifically to tracking position of assets using multiple local area networks.

A number of systems have been developed and deployed to locate and track the position of people and assets (collectively, “assets”) within local area environments such as office buildings, hospitals, shopping malls, and hotels, and/or industrial environments such as refineries, oil rigs, and manufacturing facilities. Existing systems are limited to accuracy of a few meters using an existing Wi-Fi or Bluetooth network. In addition, existing systems attempt to determine absolute position and are not able to determine proximity (e.g., two or more assets within a threshold distance from each other).

Thus there is a need for a way to provide position (and/or proximity) accuracy of one meter or less using existing infrastructure.

### SUMMARY

Devices which use IEEE 802.11 WLAN technology (also referred to as wireless fidelity or “Wi-Fi” devices) may be utilized by some embodiments to determine position of some such devices.

Many applications requiring high position location precision involve establishing close association of two assets (e.g. two persons, a person and some equipment or two pieces of equipment). In many cases, it is not necessary that the precise location of a person or object (i.e. asset) be known, but rather the association of the two is needed which requires determining that an asset is in the proximity of another asset. For instance, hospitals would like to record if a doctor or a nurse has visited a certain patient during the day. In this application, what is important is to record that the doctor/nurse was in proximity of the patient at certain time. The position location accuracy requirement for this case is often referred to as “room level” accuracy meaning that the doctor/nurse must be located in the right room. However, if the objective is to ensure that the doctor/nurse visited the patient during the day, then it is really detecting the close proximity of the doctor/nurse and the particular patient that is needed and not necessarily accurately locating the doctor/nurse. In rooms with multiple beds, the doctor/nurse must be associated with the right patient in that room. Another example of room level accuracy is in hotels where it is desirable to locate a maid in the right room in case there is an emergency, or to be able to verify that someone has cleaned a specific room.

One manufacturing use case is to adjust the torque of a wrench depending on the specific manufacturing part the tool is trying to fasten. This again is a case of detecting proximity of the tool and a manufacturing part. Another example of the need to detect proximity is to ensure that certain medical equipment such as an intravenous (IV) pump is in fact attached to a certain patient. Another example is to register that doctors/nurses have washed their hands prior to certain functions such as visiting a patient. This application again requires detection of close proximity of the doctor/nurse and a sink/disinfectant station.

Another application for accurate position location in retail environment is to direct the customer to the right location in the store for a given item. Here one would want a very accurate positioning scheme to navigate the customer through the store so that the customer gets very close to the item he/she is searching.

The preceding Summary is intended to serve as a brief introduction to various features of some exemplary embodiments. Other embodiments may be implemented in other specific forms without departing from the spirit of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of an exemplary IEEE 802.11 based position location system that uses round trip delay (RTD) measurements of messages;

FIG. 2 illustrates a schematic block diagram of an exemplary IEEE 802.11 based position location system that uses time of arrival (TOA) measurements of messages;

FIG. 3 illustrates a messaging diagram showing clock offset measurement between two beacons;

FIG. 4 illustrates a schematic block diagram of an exemplary network of beacons and associated pairwise clock offsets;

FIG. 5 illustrates a flow chart of an exemplary IEEE 802.11 position location process that uses TOA measurements;

FIG. 6 illustrates a flow chart of an exemplary process used to determine clock offset of beacons, and to correct timing offset of measured TOA values associated with the beacons; and

FIG. 7 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments generally provide ways to determine positions of elements associated with a wireless local area network.

While the present invention is described with respect to use in Wi-Fi networks and access points therein, a person of ordinary skill in the art will readily recognize other types of networks and other applications may be used without departing from the scope of the disclosure.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges may independently be included in the smaller ranges also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by a person of ordinary skill in the art to which this invention belongs. Although any methods and materials similar or equivalent to those described herein can also be used in the practice or testing of the present invention, a limited number of the exemplary methods and materials are described herein.

As used herein and in the appended claims, the singular forms “a”, “an”, and “the” include plural referents unless the context clearly dictates otherwise.

The indoor position location system described in this disclosure may use IEEE 802.11 compliant wireless local area network (WLAN) technology to provide high precision indoor position location information for tags installed on assets as well as for user devices such as smartphones or tablets that may be carried by (and/or otherwise associated with) people. Although many examples throughout the disclosure may describe IEEE 802.11 based features, other embodiments may be implemented using various other appropriate protocols.

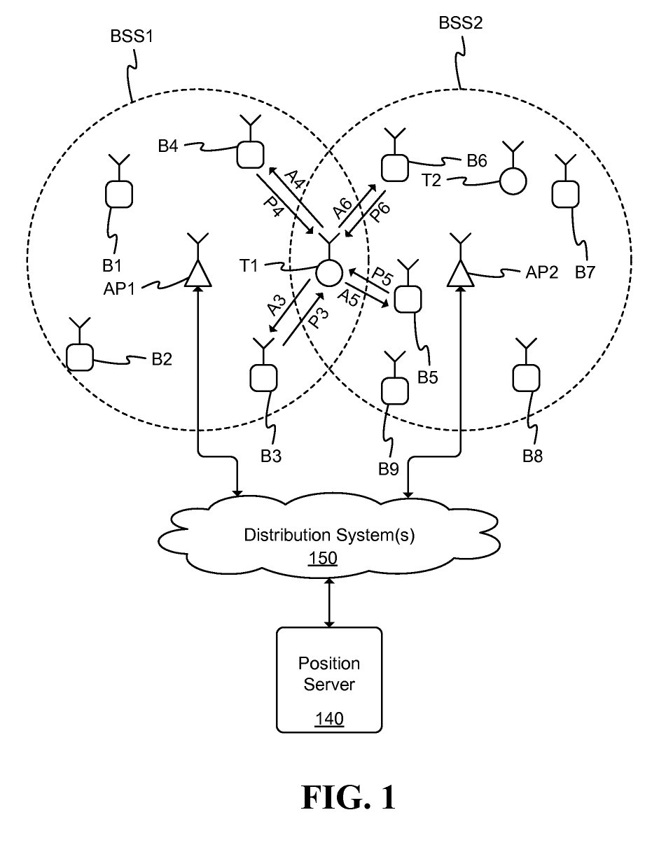

FIG. 1 illustrates a schematic block diagram of an exemplary IEEE 802.11 based system that uses round trip delay (RTD) measurements of messages to determine position. FIG. 1 shows a typical IEEE 802.11 network deployment.

As shown, this example system includes access points (APs) AP1 and AP2. Each AP forms an associated basic service set (BSS) BSS1 and BSS2, respectively. Each BSS is identified by a unique BSSID. The BSSs may be interconnected to form an extended service set (ESS), and share the same security credentials thereby facilitating easy movement of Wi-Fi devices among different BSSs.

APs may be network Wi-Fi elements that are part of existing infrastructure associated with a given building or campus. Such Wi-Fi elements may be deployed in order to provide Internet access. Beacons B1-B9 may have similar capability as APs, and may also be included in a network to provide range measurements associated with tags in order to determine the positions of the tags. In other words, beacons may be used to complement the APs in legacy Wi-Fi networks associated with a given venue. Beacons may provide the same functionality as the APs, but may typically be used to provide range measurements associated with the tags. For venues where there is no existing Wi-Fi, network beacons may be able to act as APs.

Each beacon may be enabled with IEEE 802.11 technology, and may act as an IEEE 802.11 AP or IEEE 802.11 station (STA). Mobile tags T1-T2 may be IEEE 802.11 enabled devices installed on assets and/or carried by people, and may be capable of communicating with the APs and/or beacons.

Tags, APs, and/or beacons may be used to make range measurements in order to determine position. Beacons may provide additional measurement capability compared to a network limited to APs, as in many existing 802.11 WLAN networks. Throughout the disclosure, the term “beacon” may be used to refer to APs and auxiliary beacon devices (i.e., any device with which tags and/or mobile devices may make range measurements for the purpose of position determination). “Tag” may refer to a device attached to an asset or an IEEE 802.11 enabled phone carried by a person.

Position location of a tag may be determined using RTD measurements with multiple beacons. The position location server 140 may schedule RTD measurements between pairs of tags and beacons, convert the RTD measured values to distance between beacon/tag pair, and carry out trilateration of the estimated distances from one tag to multiple beacons in order to determine the position of the tag. The computed position may be sent to (and/or otherwise made available to) other network elements. The distribution system 150 may include various network elements, interfaces, and/or devices, as appropriate.

In the example of FIG. 1, tag T1 may be making RTD measurements with beacons B3, B4, B5 and B6. Beacon B3 may send a data packet P3 to tag T1. Tag T1 may, in turn, send an acknowledgement packet A3 to beacon B3 in response to packet P3. Beacon B3 may calculate the RTD from beacon B3 to tag T1 based at least partly on the transmission time of packet P3 and the receipt time of packet A3.

Similarly, beacons B4, B5 and B6 may measure RTD with tag T1. The RTD values may be converted to distance between the tag T1 and beacons B3-B6 and used in trilateration to estimate the tag T1 position. One advantage of an RTD based position determination scheme is that the beacons need not be synchronized. A disadvantage of an RTD based scheme is that the tag must make multiple transmissions (one transmission for each RTD), and multiple receptions (one reception for each RTD), resulting in high power consumption for the tag and the beacons. Moreover, multiple RTD measurements result in high usage of the communications channel for the purpose of position determination which may adversely affect data transmission.

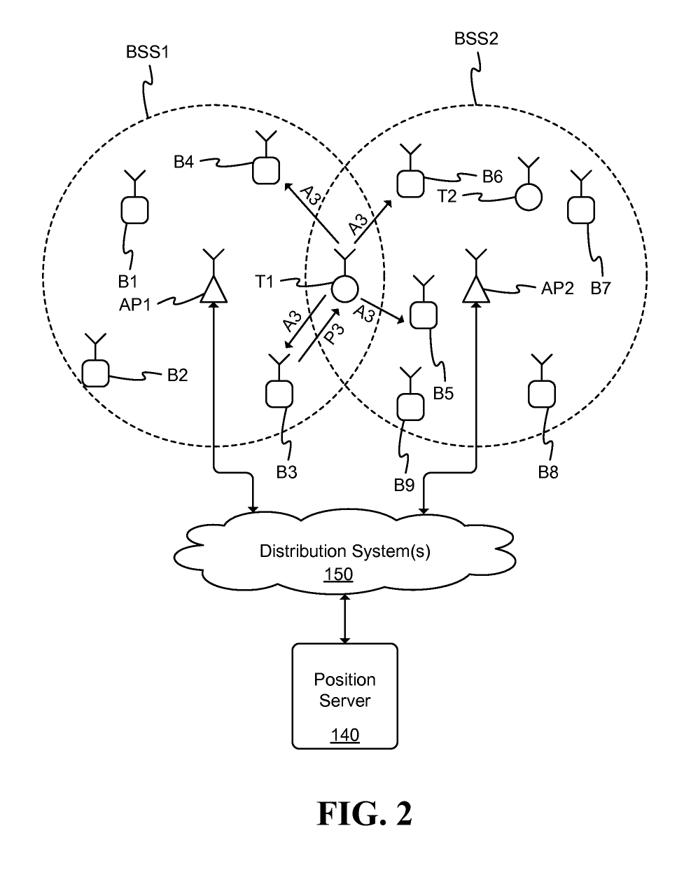

FIG. 2 illustrates a schematic block diagram of an exemplary IEEE 802.11 based position location system that uses TOA measurements to determine tag position.

In the TOA based position determination example of FIG. 2, beacon B3 may send a data packet P3 to tag T1, and tag T1 may, in turn, respond with an acknowledgement A3. Tag T1 may be associated with beacon B3 and communicate with the beacon for data transmission purposes as well as TOA measurement.

Beacons B4, B5, B6 and B9 may also receive acknowledgement message A3. These beacons B4, B5, B6, and B9, which may receive a strong enough signal from tag T1 to detect the acknowledge message A3, may measure TOA of the acknowledgement message A3 at a receiver associated with each beacon.

If only x and y coordinates of tag T1 are to be determined, then at least two TOA measurements are needed. Because clock offset of tag T1 with respect to the beacons B4, B5, B6, and B9 may not be known, an additional TOA measurement may be needed to estimate the clock offset as well as the x and y coordinates when the tag clock is not synchronized to that of the beacons. An additional TOA measurement may be used to determine the altitude of a tag.

Additional TOA measurements above any minimum requirements may be made in order to provide redundancy for the measurements. If the timing of the beacons B4, B5, B6, and B9 are synchronized, the clock timing offset of tag T1 with respect to the beacons B4, B5, B6, and B9 may be calculated in addition to the position coordinates of tag T1.

Once all the involved beacons B3, B4, B5, B6 and B9 have received the acknowledgement message A3 from tag T1 and have measured the TOA of the acknowledgement message, the beacons B4, B5, B6, and B9 may send the measured TOA values to the position location server 140 for trilateration.

In the above example, one beacon B3 prompted the measurement process by sending an IEEE 802.11 data packet to tag T1. In some embodiments, tag T1 may autonomously send a data packet which is able to be received by all beacons which can detect a signal from tag T1.

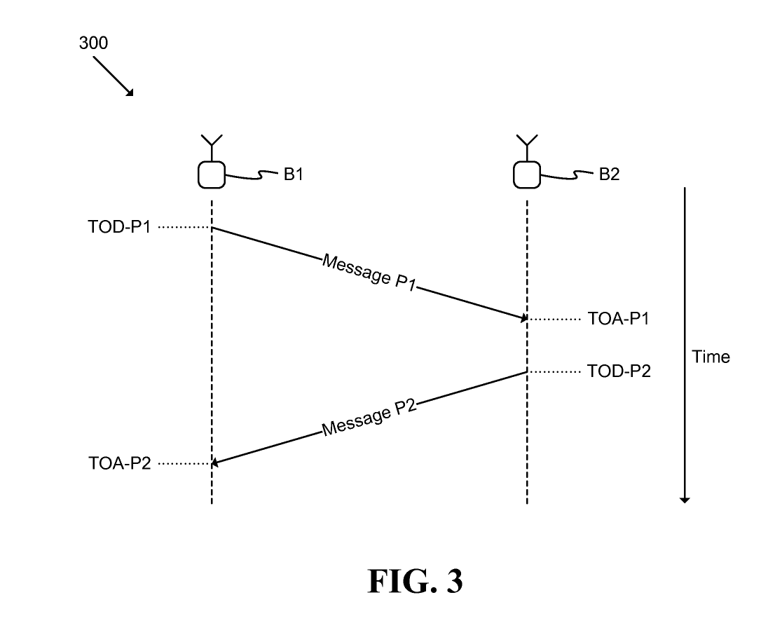

FIG. 3 illustrates a messaging diagram showing clock offset measurement between two beacons B1 and B2. As mentioned above, in order for the TOA based position location system to determine the position of a tag, the clock timing of the beacons in the network needs to be synchronized. In order to estimate clock timing offset between a pair of beacons B1 and B2, the first beacon B1 may send message P1 to the second beacon B2, and record the time of departure (TOD) of message P1 at beacon B1 (TOD-P1). The second beacon B2 may register the TOA of packet P1 at beacon B2 (TOA-P1).

The second beacon B2 may send a packet P2 to the first beacon Bl. Packet P2 may include TOA-P1 and TOD of packet P2 from beacon B2 (TOD-P2). The first beacon B1 may register the TOA of packet P2 (TOA-P2). The clock offset between the beacons B1 and B2 may be estimated using equation (1) below:

Clock Offset=[(TOA-P1−TOD-P1)−(TOA-P2−TOD-P2)]/2 (1)

Once the clock offset between two beacons is estimated, the clock timing of the second beacon may be corrected to align with that of the first beacon. Next, the clock timing of a third beacon may be synchronized to that of the second beacon. Similarly, the clock timing of each of the remaining beacons in a network may be synchronized to that of a previously synchronized beacon.

Using the beacon synchronization scheme described above, the clock timing of all beacons may be synchronized. Another approach that does not require physical synchronization of the beacon clocks is described below.

This disclosure describes systems and methods that compensate for the clock timing offset between different beacons during the position location determination step. In other words, in some embodiments the clock timing of the beacons is not synchronized at the hardware level. Instead, the estimated beacon clock offsets are sent to the position location server 140 to correct TOA measurements before the trilateration process begins. Once the clock offset between a first and a second beacon is estimated, the estimated clock offset may be forwarded to the position location server. The clock offset of each of the remaining beacons in the network may be sequentially estimated with respect to the clock of a beacon whose clock offset has already been estimated.

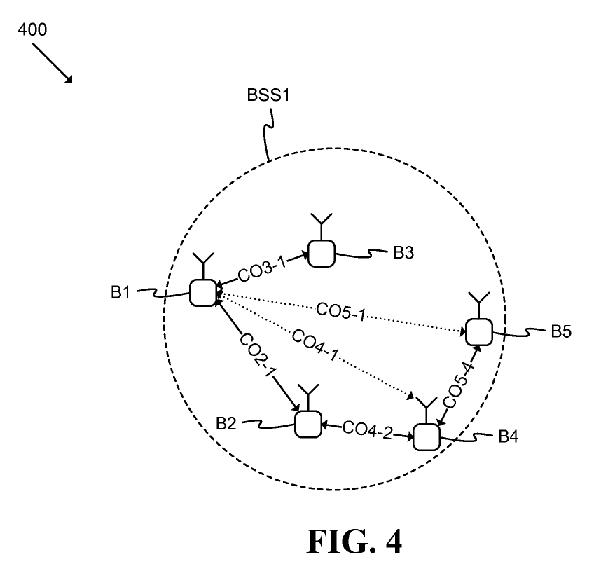

FIG. 4 illustrates a schematic block diagram of an exemplary network of beacons B1-B5 and associated pairwise clock offsets.

If a graph is created by connecting pairs of beacons whose clock offsets are estimated with respect to another beacon as described above, then the resulting graph will be a connected graph; that is, the clock offset of any Beacon in the network may be calculated with respect to any other beacon in the set using the estimated clock offsets between pairs of beacons as determined above.

All clock offsets between pairs of beacons in such a connected graph may be forwarded to the position location server 140. This example includes a network of five beacons B1-B5 in BSS BSS1. The clock offset between each pair of beacons may be calculated and a connected graph generated by connecting pairs of beacons whose clock offsets have been determined pairwise as described above.

The pairwise clock offsets between beacons, the measured TOA values, and knowledge of the position coordinates of the beacons may be sufficient for the position location server 140 to estimate tag position location coordinates. Some specific systems and methods for using the measured pairwise beacon clock offsets and measured TOA values in position location determination are described below.

In some embodiments, the position location server 140 may choose one of the available beacons as a reference beacon, and calculate the clock offsets of the remaining beacons with respect to the reference beacon. In the example of FIG. 4, beacon B1 is the reference beacon.

The clock offset CO2-1 of beacon B2 with respect to the reference beacon B1 may be calculated in a pairwise manner as described above. Likewise, the clock offset CO3-1 of of beacon B3 with respect to beacon B1 may be calculated in a pairwise manner. Clock offset CO4-1 may be calculated by summing clock offset CO2-1 and clock offset CO4-2, where clock offset CO4-2 may be calculated in a pairwise manner between beacons B4 and B2. Clock offset CO5-1 may be calculated by summing clock offset CO4-1 and clock offset CO5-4, where clock offset CO5-4 may be calculated in a pairwise manner between beacons B5 and B4.

The clock offset of all beacons with respect to a reference beacon may thus be calculated. As the reference beacon clock offset is calculated for each beacon, the offset may be summed with a paired beacon to determine the offset with respect to the reference beacon.

The computed clock offsets for all beacons may be used to correct for the timing offset between beacons when determining the position of a tag. As shown in FIG. 2, tag T1 may transmit an acknowledgement message A3 in response to the data packet P3 sent by beacon B3 to tag T1. The TOAs of acknowledgement packet A3 at beacons B3, B4, B5, B6 and B9 are denoted by TOA-B3, TOA-B4, TOA-B5, TOA-B6, and TOA-B9, respectively. If the clock timing of all beacons were synchronized, then the TOA measurements at the beacons may be used in estimating the tag T1 position using a number of appropriate algorithms. However, if the clock timings of the beacons are not directly synchronized but the clock offsets of the beacons with respect to a reference beacon are estimated, then the TOA measurements may be corrected by the position location server 140 using the clock offset values prior to using the TOA measurements for position location determination.

In some embodiments, the TOA of acknowledgement received at a beacon may be corrected by adding the clock offset from the beacon to the reference beacon to the TOA of acknowledgement packet at the beacon. The corrected TOA values, which may be equivalent to the case where the beacon clock timings are synchronized, may be used in computing tag position using various appropriate trilateration schemes.

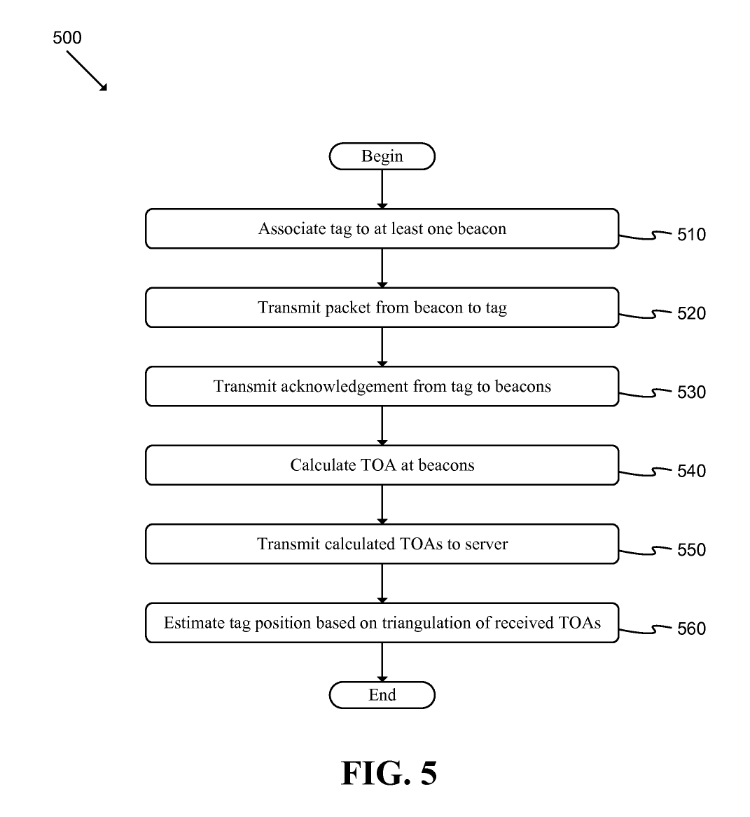

FIG. 5 illustrates a flow chart of an exemplary IEEE 802.11 position location process 500 that uses TOA measurements to estimate the position of a tag. Such a process may be implemented by systems and schemes similar to those described above in reference to FIGS. 1-4. The process is described from a system-level perspective. However, one of ordinary skill in the art will recognize that the process may be implemented, alternatively and/or conjunctively, by various system components. For instance, a beacon may execute a portion of the process while a tag executes another portion and the location server executes still another portion. Some operations may be performed by combinations of elements (e.g., a first element may transmit data that is received by a second element). The process may begin, for example, when a tag is deployed.

As shown, the process may associate (at 510) the tag to at least one beacon. Such association may involve communication between the tag and the beacon and/or other appropriate elements (e.g., server 140). Next, the process may transmit (at 520) a data packet from the beacon to the tag.

The process may then transmit (at 530) an acknowledgement message from the tag to the beacon (and/or any other beacons that are able to receive the message). Next, all beacons that detect the acknowledgement message may calculate (at 540) the TOA of the received message. The process may then transmit (at 550) the calculated TOAs from the beacons to the position server.

The process may then estimate (at 560) the tag position based on triangulation or trilateration of the TOAs received from the beacons.

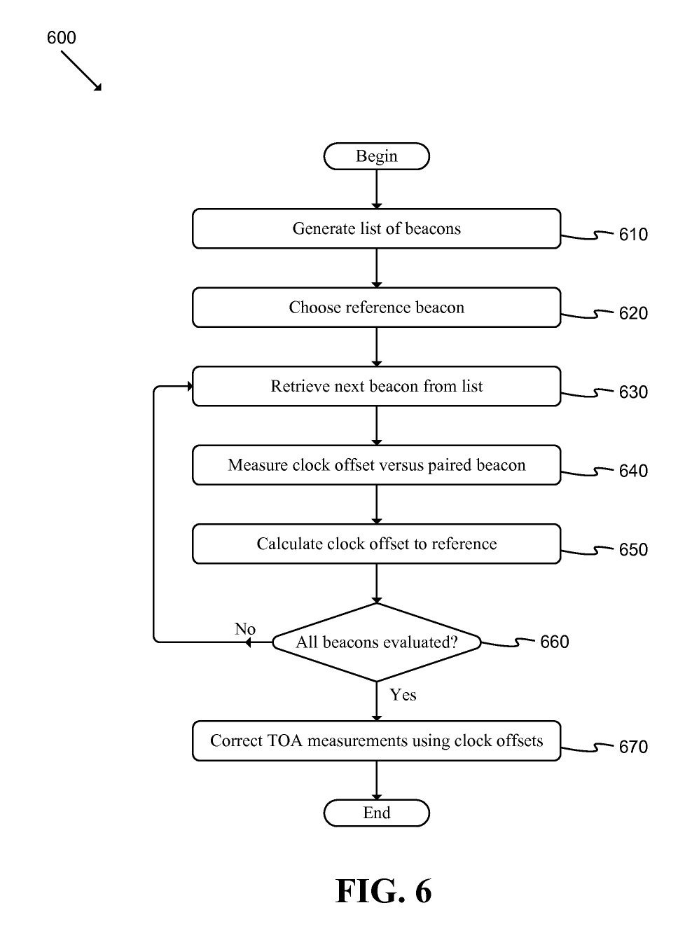

FIG. 6 illustrates a flow chart of an exemplary process 600 used to determine clock offset of beacons, and to correct timing offset of measured TOA values associated with the beacons. Such a process may be implemented by systems and schemes similar to those described above in reference to FIGS. 1-4. The process is described from a system-level perspective. However, one of ordinary skill in the art will recognize that the process may be implemented, alternatively and/or conjunctively, by various system components. For instance, a beacon may execute a portion of the process while a tag executes another portion and the location server executes still another portion. Some operations may be performed by combinations of elements (e.g., a first element may transmit data that is received by a second element). The process may begin, for example, when a location server is powered on.

As shown, the process may generate (at 610) a list of beacons. Such a list may include, for example all beacons within a BSS, all beacons within an ESS, and/or otherwise grouped beacons (e.g., beacons within communication range of a tag).

Next, the process may choose (at 620) a reference beacon. Such a choice may be made based on various appropriate sets of criteria. The process may then retrieve (at 630) a next beacon from the list and measure (at 640) clock offset versus a paired beacon. In the case of the first beacon chosen after the reference beacon, the comparison may be performed between the retrieved beacon and the reference beacon. The process may then calculate (at 650) the clock offset of the retrieved beacon and the reference beacon and add the retrieved beacon to a compensated beacon list. Such a calculation may include adding the clock offset between the retrieved beacon and the previous beacon to the clock offset between the previous beacon and the reference beacon. If the clock offset to the reference is not able to be calculated (e.g., because an intervening beacon has not yet been evaluated), the process may store the values that are able to be calculated and make any final calculations when the needed offsets have been determined. In some embodiments the paired beacon may be selected from the list of compensated beacons such that the offset versus the reference is able to be determined.

Process 600 may then determine (at 660) whether all beacons have been evaluated. If the process determines that not all beacons have been evaluated, the process may repeat operations 630-660 until the process determines (at 660) that all beacons have been evaluated.

If the process determines (at 660) that all beacons have been evaluated, the process may correct (at 670) TOA measurements using the calculated clock offsets and then may end.

Such correction of measured received acknowledgement TOA at each beacon may include addition of the beacon clock offset with respect to the reference beacon to the measured received acknowledgement TOA at the beacon.

Such corrected TOA values and knowledge of the position coordinates of the beacons may allow trilateration and/or triangulation algorithms to be used to estimate the position coordinates of the tag.

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

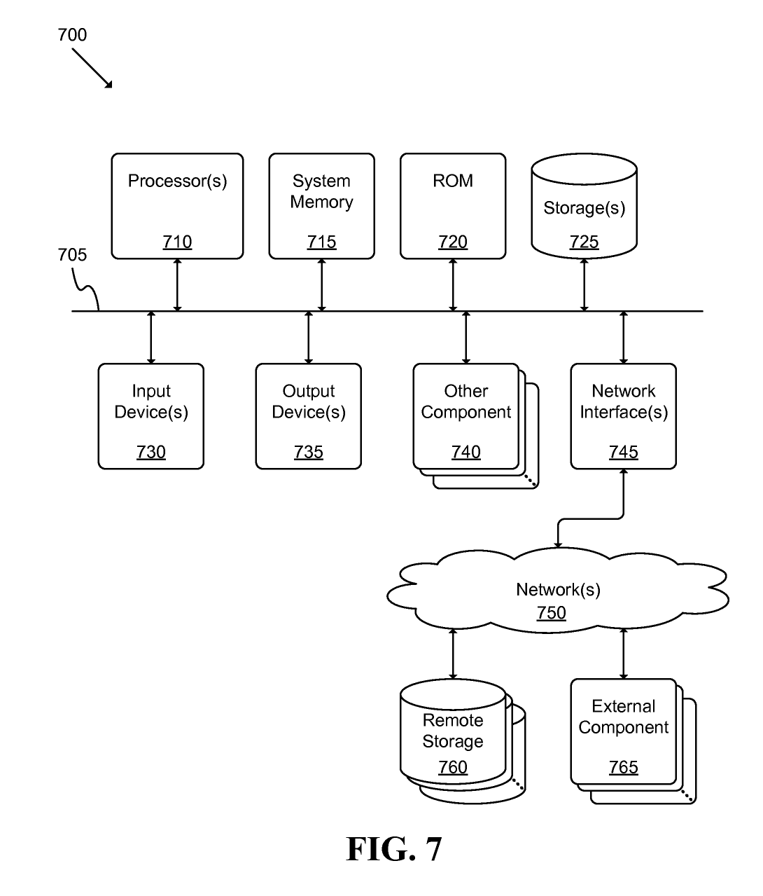

FIG. 7 illustrates a schematic block diagram of an exemplary computer system 700 used to implement some embodiments. For example, the system described above in reference to FIGS. 1-4 may be at least partially implemented using computer system 700. As another example, the processes described in reference to FIGS. 5-6 may be at least partially implemented using sets of instructions that are executed using computer system 700.

Computer system 700 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 700 may include at least one communication bus 705, one or more processors 710, a system memory 715, a read-only memory (ROM) 720, permanent storage devices 725, input devices 730, output devices 735, various other components 740 (e.g., a graphics processing unit), and one or more network interfaces 745.

Bus 705 represents all communication pathways among the elements of computer system 700. Such pathways may include wired, wireless, optical, and/or other appropriate communication pathways. For example, input devices 730 and/or output devices 735 may be coupled to the system 700 using a wireless connection protocol or system.

The processor 710 may, in order to execute the processes of some embodiments, retrieve instructions to execute and/or data to process from components such as system memory 715, ROM 720, and permanent storage device 725. Such instructions and data may be passed over bus 705.

System memory 715 may be a volatile read-and-write memory, such as a random access memory (RAM). The system memory may store some of the instructions and data that the processor uses at runtime. The sets of instructions and/or data used to implement some embodiments may be stored in the system memory 715, the permanent storage device 725, and/or the read-only memory 720. ROM 720 may store static data and instructions that may be used by processor 710 and/or other elements of the computer system.

Permanent storage device 725 may be a read-and-write memory device. The permanent storage device may be a non-volatile memory unit that stores instructions and data even when computer system 700 is off or unpowered. Computer system 700 may use a removable storage device and/or a remote storage device as the permanent storage device.

Input devices 730 may enable a user to communicate information to the computer system and/or manipulate various operations of the system. The input devices may include keyboards, cursor control devices, audio input devices and/or video input devices. Output devices 735 may include printers, displays, and/or audio devices. Some or all of the input and/or output devices may be wirelessly or optically connected to the computer system.

Other components 740 may perform various other functions. These functions may include performing specific functions (e.g., graphics processing, sound processing, etc.), providing storage, interfacing with external systems or components, etc.

Finally, as shown in FIG. 7, computer system 700 may be coupled to one or more networks 750 through one or more network interfaces 745. For example, computer system 700 may be coupled to a web server on the Internet such that a web browser executing on computer system 700 may interact with the web server as a user interacts with an interface that operates in the web browser. Computer system 700 may be able to access one or more remote storages 760 and one or more external components 765 through the network interface 745 and network 750. The network interface(s) 745 may include one or more application programming interfaces (APIs) that may allow the computer system 700 to access remote systems and/or storages and also may allow remote systems and/or storages to access computer system 700 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 700 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the spirit and scope of the disclosure as defined by the following claims.

We claim:

1. A method that determines position using IEEE 802.11 standard components, the method comprising;
transmitting a message from a tag to a network comprising a plurality of beacons, each beacon capable of communicating with the tag;
receiving the message at the plurality of beacons;
measuring, at each beacon in the plurality of beacons, a time of arrival (TOA) of the received message; and
sending the measured TOAs to a position server.

2. The method of claim 1 further comprising synchronizing the clock timing of each beacon in the plurality of beacons to a reference clock.

3. The method of claim 2 further comprising, at the position server:
designating a beacon as a reference beacon;
creating a beacon list comprising all beacons excluding the reference beacon;
instructing a second beacon in the beacon list to estimate a clock offset with respect to the clock timing of the reference beacon and to utilize the clock offset to synchronize the second beacon to the reference beacon; and
iteratively:
retrieving a next beacon in the beacon list;
estimating a clock offset of the next beacon with respect to that of a previously processed beacon; and
synchronizing the clock timing of the next beacon to that of the previously processed beacon until all beacons in the beacon list have been processed.

4. The method of claim 2, wherein the position server estimates position coordinates of the tag based at least partly on the measured TOAs.

5. The method of claim 1, wherein each beacon measures clock offsets with respect to the clock timing of a reference beacon and sends the measure clock offset to the position server.

6. The method of claim 5, wherein the position location server uses the estimated clock offsets between beacons to correct the measured TOAs of the beacons to correspond to a synchronous network of beacons.

7. The method of claim 6, wherein the position server uses the clock offset estimate among the beacons as well as the measured TOAs at the beacons to estimate tag position coordinates.

8. The method of claim 5 further comprising, at the position server:
designating a beacon as a reference beacon;
creating a beacon list comprising all beacons excluding the reference beacon;
estimating a clock offset of the next beacon with respect to that of a previously processed beacon; and
iteratively:
retrieving a next beacon in the beacon list;
estimating a clock offset of the next beacon with respect to that of a previously processed beacon; and
recording the estimated clock offset, until all beacons in the beacon list have been processed.

9. The method of claim 8, wherein the position server:
designates a beacon as a reference beacon;
creates a beacon list comprising all beacons excluding the reference beacon; and
iteratively:
retrieves a next beacon in the beacon list; and
corrects TOA measurement of the next beacon by adding the clock offset of the next beacon with respect to the reference beacon to the measured TOA, until all beacons in the beacon list have been processed.

10. The method of claim 8, wherein the position location server uses the corrected TOA measurements for trilateration to estimate tag position coordinates.

11. A system that determines position using IEEE 802.11 standard components, the system comprising:
a processor for executing a set of instructions; and
a non-transitory medium that stores the set of instructions, wherein the set of instructions:
transmits a message from a tag to a network comprising a plurality of beacons, each beacon capable of communicating with the tag;
receives the message at the plurality of beacons;
measures, at each beacon in the plurality of beacons, a time of arrival (TOA) of the received message; and
sends the measured TOAs to a position server.

12. The system of claim 11, wherein the set of instructions further synchronizes the clock timing of each beacon in the plurality of beacons to a reference clock.

13. The system of claim 12, wherein the set of instructions further:
designates a beacon as a reference beacon;
creates a beacon list comprising all beacons excluding the reference beacon;
instructs a second beacon in the beacon list to estimate a clock offset with respect to the clock timing of the reference beacon and to utilize the clock offset to synchronize the second beacon to the reference beacon; and
iteratively:
retrieves a next beacon in the beacon list;
estimates a clock offset of the next beacon with respect to that of a previously processed beacon; and
synchronizes the clock timing of the next beacon to that of the previously processed beacon until all beacons in the beacon list have been processed.

14. The system of claim 12, wherein the position server estimates position coordinates of the tag based at least partly on the measured TOAs.

15. The system of claim 11, wherein each beacon measures clock offsets with respect to the clock timing of a reference beacon and sends the measure clock offset to the position server, and the set of instructions further:
designates a beacon as a reference beacon;
creates a beacon list comprising all beacons excluding the reference beacon;
estimates a clock offset of the next beacon with respect to that of a previously processed beacon; and
iteratively:
retrieves a next beacon in the beacon list;
estimates a clock offset of the next beacon with respect to that of a previously processed beacon; and
records the estimated clock offset, until all beacons in the beacon list have been processed.

16. A position server that determines position using IEEE 802.11 standard components, the position server comprising:
a processor for executing a set of instructions; and
a non-transitory medium that stores the set of instructions, wherein the set of instructions:
directs a tag to transmit a message to a network comprising a plurality of beacons, each beacon capable of communicating with the tag;
receives a measured TOA from each beacon in the plurality of beacons.

17. The position server of claim 16, wherein:
each beacon measures clock offset with respect to the clock timing of a reference beacon and the measured clock offsets are received at the position server, and
the position server uses the estimated clock offsets between beacons to correct the measured TOAs of the beacons to correspond to a synchronous network of beacons

18. The position server of claim 17, wherein the position server uses the clock offset estimate among the beacons as well as the measured TOAs at the beacons to estimate tag position coordinates.

19. The position server of claim 16, wherein the set of instructions further:
designates a beacon as a reference beacon;
creates a beacon list comprising all beacons excluding the reference beacon;
estimates a clock offset of the next beacon with respect to that of a previously processed beacon; and
iteratively:
retrieves a next beacon in the beacon list;
estimates a clock offset of the next beacon with respect to that of a previously processed beacon; and
records the estimated clock offset, until all beacons in the beacon list have been processed.

20. The position server of claim 19, wherein the set of instructions further:
designates a beacon as a reference beacon;
creates a beacon list comprising all beacons excluding the reference beacon; and
iteratively:
retrieves a next beacon in the beacon list; and
corrects TOA measurement of the next beacon by adding the clock offset of the next beacon with respect to the reference beacon to the measured TOA, until all beacons in the beacon list have been processed.
